(19) United States
(12) Patent Application Publication
(10) Pub. No.: US 2010/0232524 A1
(43) Pub. Date: Sep. 16, 2010

(54) METHOD AND APPARATUS FOR SYSTEM BANDWIDTH INDICATION

(75) Inventors: Wanshi Chen, San Diego, CA (US); Peter Gaal, San Diego, CA (US); Tingfang Ji, San Diego, CA (US); Juan Montojo, San Diego, CA (US); Nathan E. Tenny, Poway, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/718,216

(22) Filed: Mar. 5, 2010

Related U.S. Application Data
(60) Provisional application No. 61/159,737, filed on Mar. 12, 2009.
(60) Provisional application No. 61/161,584, filed on Mar. 19, 2009.

(51) Int. Cl. H04L 27/00; H04B 7/00

(52) U.S. Cl. 375/259; 455/509

(57) ABSTRACT

Techniques for conveying system bandwidths in a wireless communication system are described. In an aspect, system bandwidth information may be signaled to first user equipments (UEs) supporting a first set of system bandwidths and second UEs supporting a second set of system bandwidths. In one design, a base station may obtain and broadcast system bandwidth information indicating a first system bandwidth for the first UEs and a second system bandwidth for the second UEs. The first system bandwidth may be selected from the first set, and the second system bandwidth may be selected from the second set, which may be a superset of the first set. The system bandwidth information may include a first part and a second part. The first part may convey the first system bandwidth for the first UEs. The first and second parts may convey the second system bandwidth for the second UEs.

The present application claims priority to provisional U.S. Application Ser. No. 61/159,737, entitled “METHOD AND APPARATUS FOR SYSTEM BANDWIDTH INDICATION,” filed Mar. 12, 2009, and provisional U.S. Application Ser. No. 61/161,584, entitled “METHOD AND APPARATUS FOR SYSTEM BANDWIDTH INDICATION,” filed Mar. 19, 2009, both incorporated herein by reference.

### BACKGROUND

I. Field

The present disclosure relates generally to communication, and more specifically to techniques for conveying system bandwidth in a wireless communication system.

II. Background

Wireless communication systems are widely deployed to provide various communication content such as voice, video, packet data, messaging, broadcast, etc. These wireless systems may be multiple-access systems capable of supporting multiple users by sharing the available system resources. Examples of such multiple-access systems include Code Division Multiple Access (CDMA) systems, Time Division Multiple Access (TDMA) systems, Frequency Division Multiple Access (FDMA) systems, Orthogonal FDMA (OFDMA) systems, and Single-Carrier FDMA (SC-FDMA) systems.

A wireless communication system may operate with a configurable system bandwidth, which may be selected from a set of system bandwidths supported by the system. The selected system bandwidth may be broadcast by a base station to user equipments (UEs) to enable proper operation by the UEs. It may be desirable to efficiently convey the selected system bandwidth to the UEs.

### SUMMARY

Techniques for conveying system bandwidths for the downlink and/or uplink in a wireless communication system are described herein. In an aspect, system bandwidth information may be signaled to UEs of different types, which may include first UEs supporting a first set of system bandwidths and second UEs supporting a second set of system bandwidths. The first UEs and the second UEs may support different system releases and/or may have different capabilities.

In one design, a base station may obtain and broadcast system bandwidth information indicating a first system bandwidth for the first UEs and a second system bandwidth for the second UEs. The first system bandwidth may be selected from the first set of system bandwidths, and the second system bandwidth may be selected from the second set of system bandwidths. The second set may be a superset of the first set. In one design, the system bandwidth information may include a first part and a second part. The first part may convey the first system bandwidth for the first UEs. The first and second parts may convey the second system bandwidth for the second UEs. The first and second parts may be defined in various manners, as described below.

In one design, the first system bandwidth may be non-zero if the first part includes a value within a range of valid values. The base station may be inaccessible by the first UEs (and the first system bandwidth may be considered to be zero to the first UEs) if the first part includes a reserved value.

In one design, the second system bandwidth may be equal to the first system bandwidth if the first part includes a value within the range of valid values. The second system bandwidth may be determined based on the second part if the first part includes a reserved value. Alternatively, the second system bandwidth may be determined based on the second part and the reserved value if it is included in the first part.

In another design, the second system bandwidth may be equal to the first system bandwidth if the first part includes a value within the range of valid values and the second part includes a designated value. If the first part includes a valid value, then the second system bandwidth may be determined based on the valid value in the first part and a second value in the second part. If the first part includes a reserved value, then the second system bandwidth may be determined based on the reserved value in the first part and the second value in the second part.

Various aspects and features of the disclosure are described in further detail below.

### BRIEF DESCRIPTION OF THE DRAWINGS

FIG. 1 shows a wireless communication system.

FIGS. 2A and 2B show two formats of a master information block (MIB).

FIGS. 3A, 3B and 3C show three designs of conveying different system bandwidths to the first UEs and the second UEs.

FIG. 4 shows a process for sending system bandwidth information.

FIG. 5 shows an apparatus for sending system bandwidth information.

FIG. 6 shows a process for receiving system bandwidth information.

FIG. 7 shows an apparatus for receiving system bandwidth information.

FIG. 8 shows a block diagram of a base station and a UE.

### DETAILED DESCRIPTION

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband CDMA (WCDMA), Time Division Synchronous CDMA (TD-SCDMA), and other variants of CDMA. cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, etc. UTRA and E-UTRA are part of Universal Mobile Telecommunication System (UMTS). 3GPP Long Term Evolution (LTE) and LTE-Advanced (LTE-A), in both frequency division duplexing (FDD) and time division duplexing (TDD), are new releases of UMTS that use E-UTRA, which employs OFDMA on the downlink and SC-FDMA on the uplink. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). The techniques described herein may be used for the systems and radio technologies mentioned above as well as other systems and radio technologies. For clarity, certain aspects of the techniques are described below for LTE, and LTE terminology is used in much of the description below.

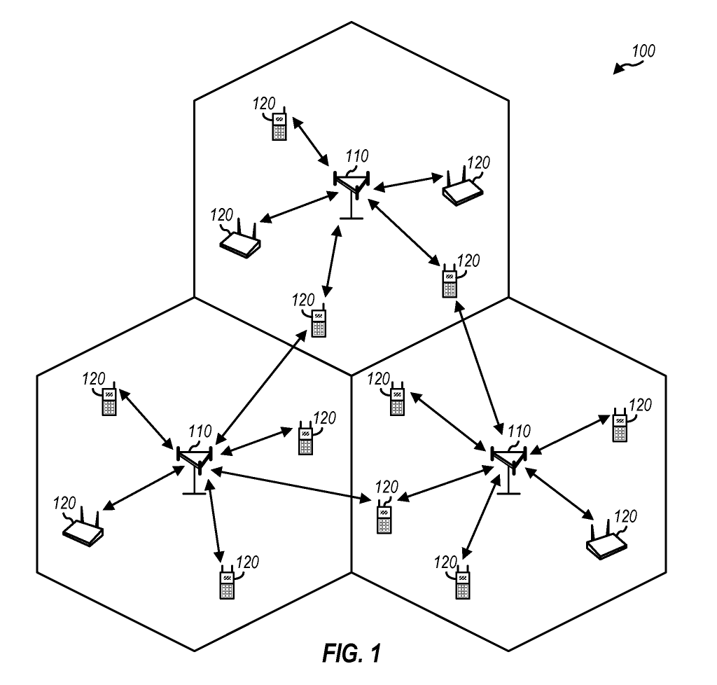

FIG. 1 shows a wireless communication system 100, which may be an LTE system or some other system. System 100 may include a number of evolved Node Bs (eNBs) 110 and other network entities. An eNB may be a station that communicates with the UEs and may also be referred to as a Node B, a base station, an access point, etc. Each eNB 110 may provide communication coverage for a particular geographic area and may support communication for UEs located within the coverage area. To improve system capacity, the overall coverage area of an eNB may be partitioned into multiple (e.g., three) smaller areas. Each smaller area may be served by a respective eNB subsystem. In 3GPP, the term “cell” can refer to the smallest coverage area of an eNB and/or an eNB subsystem serving this coverage area.

UEs 120 may be dispersed throughout the system, and each UE may be stationary or mobile. A UE may also be referred to as a mobile station, a terminal, an access terminal, a subscriber unit, a station, etc. A UE may be a cellular phone, a personal digital assistant (PDA), a wireless modem, a wireless communication device, a handheld device, a laptop computer, a cordless phone, a wireless local loop (WLL) station, a smart phone, a netbook, a smartbook, etc. A UE may communicate with an eNB via the downlink and uplink. The downlink (or forward link) refers to the communication link from the eNB to the UE, and the uplink (or reverse link) refers to the communication link from the UE to the eNB.

LTE utilizes orthogonal frequency division multiplexing (OFDM) on the downlink and single-carrier frequency division multiplexing (SC-FDM) on the uplink. OFDM and SC-FDM partition a frequency range into multiple (N_{FFT}) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (N_{FFT}) may be dependent on the system bandwidth. For example, the subcarrier spacing may be 15 kilohertz (KHz), and N_{FFT} may be equal to 128, 256, 512, 1024 or 2048 for system bandwidth of 1.4, 3, 5, 10 or 20 megahertz (MHz), respectively.

The available time frequency resources may be partitioned into resource blocks. Each resource block may cover 12 subcarriers in one slot. The number of resource blocks in each slot may be dependent on the system bandwidth and may range from 6 to 110 for system bandwidth of 1.25 to 20 MHz, respectively.

The system may operate with a configurable system bandwidth for the downlink, which may be selected from a set of system bandwidths supported for the downlink. LTE Releases 8 and 9 support six system bandwidths for the downlink, which are listed in Table 1. Each supported system bandwidth is assigned a different 3-bit value/index. Table 1 lists the 3-bit value of each supported system bandwidth.

TABLE 1
Supported System Bandwidths in LTE Releases 8 & 9

| | | |
|---|---|---|
| | | Number of |
| 3-bit | System | Resource |
| Value | Bandwidth | Blocks |

| | | | |
|---|---|---|---|
| 000 | 1.4 | MHz | 6 |
| 001 | 3 | MHz | 15 |
| 010 | 5 | MHz | 25 |
| 011 | 10 | MHz | 50 |
| 100 | 15 | MHz | 75 |
| 101 | 20 | MHz | 100 |

| | | |
|---|---|---|
| 110 | Reserved | Reserved |
| 111 | Reserved | Reserved |

As shown in Table 1, six 3-bit values of 000 through 101 (binary) are used for the six supported system bandwidths, and two 3-bit values of 110 and 111 (binary) are reserved and not used. Radio Resource Control (RRC) in LTE Releases 8 and 9 does not allow the two reserved values to be signaled over the air. Thus, if a UE that supports LTE Release 8 or 9 receives one of the reserved values from a cell, then the UE will experience an ASN.1 decoding failure and will consider the cell as being barred from use.

A cell may convey a selected system bandwidth for the downlink by broadcasting the 3-bit value of the selected system bandwidth in a master information block (MIB). The MIB is a small message that is broadcast periodically by the cell.

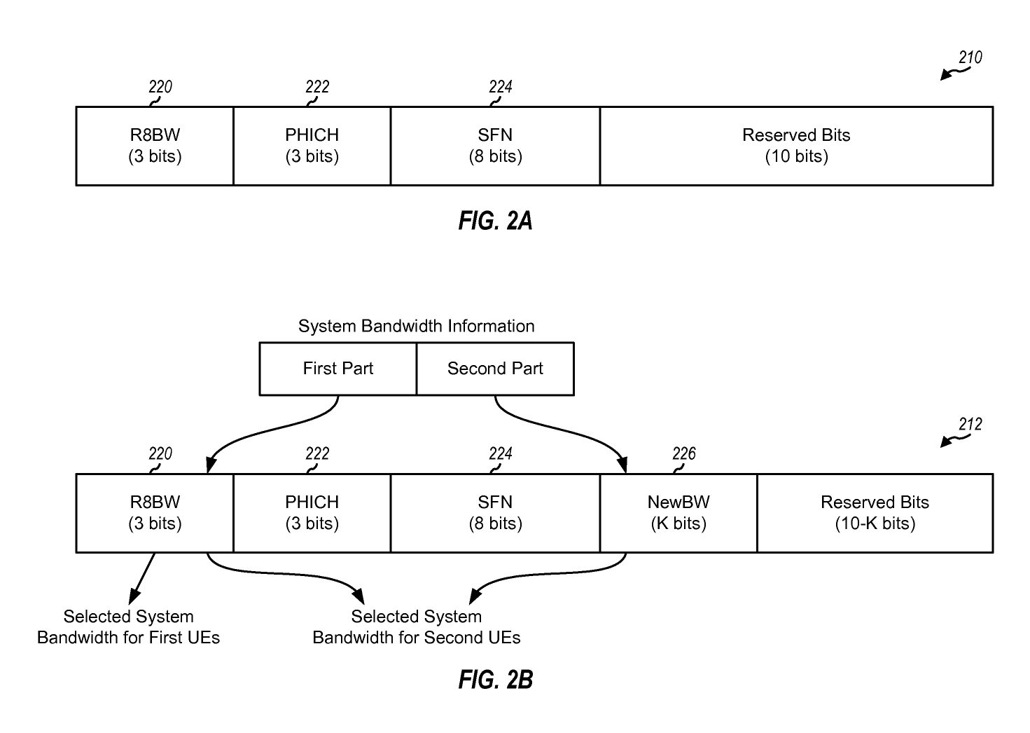

FIG. 2A shows a format 210 of the MIB in LTE Releases 8 and 9. The MIB includes a total of 24 bits, which include 14 information bits and 10 reserved bits in LTE Releases 8 and 9. The information portion of the MIB includes a 3-bit R8BW field 220 for downlink system bandwidth, 3-bit PHICH field 222 for Physical HARQ Indicator Channel (PHICH) configuration, and an 8-bit SFN field 224 for system frame number (SFN). A 3-bit value for a selected system bandwidth may be sent in the R8BW field.

LTE Release 10 and later may support more than six system bandwidths for the downlink. This may allow a system to more fully utilize the available spectrum, which may not match one of the six system bandwidths shown in Table 1. The physical layer in LTE can readily support a system bandwidth ranging from 6 to 110 resource blocks. Additional system bandwidths may be supported for the downlink by using one or more additional bits for system bandwidth information.

In an aspect, system bandwidth information may be signaled to UEs of different types, which may include first/legacy UEs and second/new UEs. The legacy UEs may support a first set of system bandwidths, e.g., the set of six system bandwidths defined in LTE Releases 8 and 9 and shown in Table 1. The new UEs may support a second set of system bandwidths, which may include the system bandwidths in the first set as well as additional system bandwidths that may be defined in LTE Release 10 or later. The system bandwidth information may be defined to be backward compatible for the legacy UEs. This may allow the legacy UEs to determine a selected system bandwidth for these UEs (from the first set of system bandwidths) based on the system bandwidth information. This may also allow the new UEs to determine a selected system bandwidth for these UEs (from the second set of system bandwidths) based on the same system bandwidth information.

In one design, the system bandwidth information may comprise a first part and a second part. The first part may convey a selected system bandwidth from the first set for the legacy UEs. The first and second parts may convey a selected system bandwidth from the second set for the new UEs. For LTE, the first part may include the 3 bits in the R8BW field used to convey the 6 supported system bandwidths on the downlink in LTE Releases 8 and 9. The second part may include one or more additional bits. In general, the system bandwidth information may comprise any number of parts, which may be defined in any manner. For clarity, much of the description below assumes that the system bandwidth information comprises the first and second parts.

In one design, the system bandwidth information may be defined based on one or both of the following:
Non-reused bitmapping—the first part of the system bandwidth information has the same interpretation by the legacy UEs and the new UEs, or
Reused bitmapping—the first part of the system bandwidth information may have different interpretations by the legacy UEs and the new UEs.

For the non-reused bitmapping, the six 3-bit values defined in LTE Releases 8 and 9 for the 6 supported system bandwidths on the downlink have the same interpretation in LTE Release 10 or later. Thus, if the R8BW field has a value of 000, 001, 010, 011, 100 or 101 (binary), then the legacy UEs and the new UEs would have the same interpretation of the selected system bandwidth, regardless of the additional bit(s) introduced for system bandwidth information in LTE Release 10 or later. The non-reused bitmapping implies that if a given cell is accessible by both the legacy UEs and the new UEs, then all UEs have the same interpretation of the selected system bandwidth. Furthermore, the non-reused bitmapping implies that the system bandwidths defined in LTE Releases 8 and 9 are entirely characterized by the content of the R8BW field, even if the cell is not accessible by the legacy UEs.

For the reused bitmapping, the six 3-bit values defined in LTE Releases 8 and 9 may have different interpretations in LTE Release 10 or later. Thus, if the R8BW field has a value of 000, 001, 010, 011, 100 or 101 (binary), then the legacy UEs and the new UEs may have different interpretations of the selected system bandwidth, depending on the additional bit(s) introduced for system bandwidth information in LTE Release 10 or later.

A selected system bandwidth for the downlink may be conveyed in various manners. It may be desirable to define the system bandwidth information to be backward compatible for the legacy UEs and to support additional system bandwidths for the new UEs. Some schemes for defining the system bandwidth information to satisfy both of these goals are described below.

In a first scheme, a selected system bandwidth for the downlink may be conveyed using two fields for two groups of system bandwidths supported for the downlink. A first group may include the six system bandwidths defined in LTE Releases 8 and 9 and shown in Table 1. A second group may include additional system bandwidths defined in LTE Release 10 or later. The first set of system bandwidths supported by the legacy UEs may include the first group of system bandwidths. The second set of system bandwidths supported by the new UEs may include both the first and second groups of system bandwidths. The selected system bandwidth may be conveyed using one of the two fields depending on whether the selected system bandwidth is from the first or second group. The first scheme utilizes the non-reused bitmapping described above.

FIG. 2B shows a design of a format 212 of the MIB with two fields for downlink system bandwidth. In the design shown in FIG. 2B, the information portion of the MIB includes 3-bit R8BW field 220 for downlink system bandwidth, 3-bit PHICH field 222 for PHICH configuration, 8-bit SFN field 224 for SFN, and a K-bit NewBW field 226 for downlink system bandwidth. The first part of the system bandwidth information may be sent in the R8BW field. The second part of the system bandwidth information may be sent in the NewBW field.

The size of the NewBW field may be dependent on the number of additional system bandwidths to support. In general, up to 2^{K} additional system bandwidths may be supported with K bits for the NewBW field by the first scheme. For example, the NewBW field may include 3 bits to support up to 8 additional system bandwidths defined in LTE Release 10 or later. This would then result in a total of 6 bits used to convey the selected system bandwidth for the downlink in LTE Release 10 or later. Each additional system bandwidth may be assigned a different K-bit value.

Table 2 shows the use of the R8BW field and the NewBW field to convey a selected system bandwidth for the downlink in accordance with one design of the first scheme. If the selected system bandwidth is from the first group of system bandwidths, then the 3-bit value for this system bandwidth may be sent in the R8BW field, and any value may be sent in the NewBW field, as indicated by the first row of Table 2. The legacy UEs and the new UEs can both determine the selected system bandwidth based on the 3-bit value sent in the R8BW field. The new UEs may ignore the NewBW field.

TABLE 2
System Bandwidth Information for First Scheme

| R8BW | NewBW | Legacy UE | New UE |
|---|---|---|---|
| Value | Value | Interpretation | Interpretation |
| 000-101 | Ignored | BW = R8BW | BW = R8BW |
| 110-111 | yyy | Cell barred | BW = yyy |

Conversely, if the selected system bandwidth is from the second group of system bandwidths, then a K-bit value (denoted as “yyy”) for this system bandwidth may be sent in the NewBW field, and either 110 or 111 (binary) may be sent in the R8BW field, as indicated by the second row of Table 2. The legacy UEs may receive either 110 or 111 (binary) from the R8BW field and may consider the cell as being barred. This may be the correct behavior for the legacy UEs. The new UEs may also receive either 110 or 111 (binary) from the R8BW field and may recognize that the selected system bandwidth is from the second group. The new UEs may receive the K-bit value from the NewBW field and may determine the selected system bandwidth based on this K-bit value.

For the first scheme, the R8BW field may be used to (i) convey the selected system bandwidth if it is from the first group or (ii) indicate that the selected system bandwidth is conveyed by the NewBW field if it is from the second group.

The use of two fields to convey the selected system bandwidth for the downlink may provide backward compatibility while simplifying operation. However, more bits may be used to convey the selected system bandwidth. For example, the first group may include 6 supported system bandwidths, and the second group may include 8 supported system bandwidths. The R8BW field may include 3 bits, and the NewBW field may include 3 bits. A total of 6 bits may be used to convey one of 6+8=14 supported system bandwidths, which translates to 4 bits worth of information. Hence, conveying the 2 groups of system bandwidths separately in two fields effectively uses 2 additional bits. Although the 2 bits represent a small absolute number, it may be desirable to reduce the number of additional bits given the limited size of the MIB.

In a second scheme, a selected system bandwidth for the downlink may be conveyed using two fields for two groups of system bandwidths supported for the downlink, similar to the first scheme. However, the two reserved values for the R8BW field may be used for one of the additional bits, which may then result in a saving of one bit over the first scheme. The second scheme also utilizes the non-reused bitmapping described above.

For the second scheme, a first group may include the six system bandwidths defined in LTE Releases 8 and 9 and shown in Table 1. A second group may include additional system bandwidths defined in LTE Release 10 or later. Up to 2^{K} additional system bandwidths may be supported with K−1 bits for the NewBW field. Each additional system bandwidth may be assigned a different K-bit value.

Table 3 shows the use of the R8BW field and the NewBW field to convey a selected system bandwidth for the downlink in accordance with one design of the second scheme. If the selected system bandwidth is from the first group, then the 3-bit value for the selected system bandwidth may be sent in the R8BW field, and any value may be sent in the NewBW field, as indicated by the first row of Table 3. The legacy UEs and the new UEs can both determine the selected system bandwidth based on the 3-bit value sent in the R8BW field. The new UEs may ignore the NewBW field.

TABLE 3
System Bandwidth Information for Second Scheme

| R8BW | NewBW | Legacy UE | New UE |
|---|---|---|---|
| Value | Value | Interpretation | Interpretation |
| 000-101 | Ignored | BW = R8BW | BW = R8BW |
| 110 | yy | Cell barred | BW = 0yy |
| 111 | yy | Cell barred | BW = 1yy |

Conversely, if the selected system bandwidth is from the second group, then the K-bit value for the selected system bandwidth may be sent in both the R8BW field and the NewBW field. In one design that is shown in Table 3, the most significant bit (MSB) of the K-bit value for the selected system bandwidth may be sent using the two reserved values for the R8BW field. In particular, if the MSB is equal to 0, then 110 (binary) may be sent in the R8BW field, as indicated by the second row of Table 3. Alternatively, if the MSB is equal to 1, then 111 (binary) may be sent in the R8BW field, as indicated by the third row of Table 3. Regardless of the value of the MSB, the K−1 remaining bits of the K-bit value for the selected system bandwidth may be sent in the NewBW field, as indicated by “yy” in the second column of Table 3.

If the selected system bandwidth is from the second group, then the legacy UEs may receive either 110 or 111 (binary) from the R8BW field and may consider the cell as being barred. The new UEs may also receive either 110 or 111 (binary) from the R8BW field and may recognize that the selected system bandwidth is from the second group. The new UEs may obtain either 0 or 1 for the MSB based on whether 110 or 111 (binary) was received from the R8BW field. The new UEs may also receive K−1 bits from the NewBW field and may concatenate the MSB with the K−1 bits to obtain a K-bit value. The new UEs may then determine the selected system bandwidth based on the K-bit value obtained from both the R8BW field and the NewBW field.

Table 3 shows a design in which the MSB of the K-bit value for the selected system bandwidth from the second group is implicitly conveyed by the two reserved values for the R8BW field. In general, any bit of the K-bit value may be implicitly conveyed. The implicitly conveyed bit in the R8BW field may be concatenated at the proper bit position with the K−1 explicitly conveyed bits in the NewBW field to obtain the K-bit value.

The second scheme uses the two reserved values for the R8BW field to convey one bit for a selected system bandwidth from the second group. These two reserved values may be signaled by new cells supporting LTE Release 10 or later and may be understood by the new UEs but not the legacy UEs.

The second scheme can support the same number of additional system bandwidths using one fewer additional bit than the first scheme. For example, up to 8 additional system bandwidths may be supported by the second scheme using 2 additional bits and by the first scheme using 3 additional bits. Equivalently, the second scheme can support twice the number of additional system bandwidths using same number of additional bits as the first scheme.

In a third scheme, one or more selected system bandwidths for the downlink may be conveyed using two fields, with one field controlling interpretation of the other field. The third scheme utilizes the reused bitmapping described above and allows a given cell to convey the same or different selected downlink system bandwidths for the legacy UEs and the new UEs.

For the third scheme, a first group may include the six system bandwidths defined in LTE Releases 8 and 9 and shown in Table 1. M additional groups of system bandwidths may be defined in LTE Release 10 or later, and each additional group may include up to six additional system bandwidths. Each of the M+1 total groups may be assigned a different K-bit value, where 2^{K}≧M+1. Up to 2^{K}−1 additional groups of system bandwidths may be supported with K bits for the NewBW field.

Table 4 shows the use of the R8BW field and the NewBW field to convey one or more selected system bandwidths for the downlink in accordance with a first design of the third scheme. In this design, the NewBW field includes 2 bits and supports 3 additional groups of system bandwidths. The first group of system bandwidths is denoted as R8BW and is assigned a value of 00 (binary) for the NewBW field. The 3 additional groups include (i) a first additional group denoted as NewBW1 and assigned a value of 01 (binary) for the NewBW field, (ii) a second additional group denoted as NewBW2 and assigned a value of 10 (binary), and (iii) a third additional group denoted as NewBW3 and assigned a value of 11 (binary).

TABLE 4
System Bandwidth Information for First Design of Third Scheme

| R8BW | NewBW | Legacy UE | New UE |
|---|---|---|---|
| Value | Value | Interpretation | Interpretation |
| 000-101 | 00 | BW = R8BW | BW = R8BW |
| | 01 | BW = R8BW | BW = NewBW1 |
| | 10 | BW = R8BW | BW = NewBW2 |
| | 11 | BW = R8BW | BW = NewBW3 |
| 110-111 | Ignored | Reserved | Reserved |

To convey a selected system bandwidth from the first group to both the legacy UEs and the new UEs, the 3-bit value for the selected system bandwidth may be sent in the R8BW field, and 00 (binary) may be sent in the NewBW field, as indicated by the first row of Table 4. To convey a first selected system bandwidth from the first group to the legacy UEs as well as a second selected system bandwidth from an additional group to the new UEs, the 3-bit value for the first selected system bandwidth may be sent in the R8BW field, and a non-zero value may be sent in the NewBW field, as indicated by the second, third and fourth rows of Table 4.

For both cases described above, the legacy UEs may obtain the 3-bit value from the R8BW field and may determine the selected system bandwidth for the legacy UEs based on the 3-bit value. The new UEs may obtain the 3-bit value from the R8BW field as well as the 2-bit value from the NewBW field and may determine the selected system bandwidth for the new UEs based on both the 3-bit value and the 2-bit value.

Table 4 shows a design in which M=3 additional groups of system bandwidths are supported for the new UEs with K=2 additional bits for the NewBW field. Fewer or more additional groups of system bandwidths may also be supported with fewer or more bits for the NewBW field.

The M additional groups of system bandwidths NewBW1 through NewBWM may be defined in various manners. The M additional groups of system bandwidths may be related to the first group of system bandwidths. This is because an R8BW value used to convey a selected system bandwidth from the first group to the legacy UEs is also used to convey a selected system bandwidth from one of the additional groups to the new UEs.

In one design, for each valid R8BW value within the range of 000 to 101 (binary), up to M different absolute system bandwidths may be defined for NewBW1 through NewBWM corresponding to that R8BW value. As an example, for an R8BW value of 000 (binary), NewBW1 may be equal to 1.4 MHz, NewBW2 may be equal to 2.5 MHz, NewBW3 may be equal to 3.0 MHz, etc. The same absolute system bandwidth may be used for more than one NewBW value. In general, any system bandwidth may be defined for NewBW1 through NewBWM for each valid R8BW value. NewBW1 through NewBWM may also be assigned system bandwidths that are most likely to be used for the new UEs when the corresponding R8BW is used for the legacy UEs. As an example, for an R8BW value of 000 (binary) corresponding to 1.4 MHz system bandwidth, NewBW1 through NewBWM may be assigned system bandwidths that are most likely to be used for the new UEs when 1.4 MHz system bandwidth is used for the legacy UEs.

In another design, for each valid R8BW value, up to M different bandwidth operation scenarios may be indicated by NewBW1 through NewBWM. Each bandwidth operation scenario may be assigned a different NewBW value.

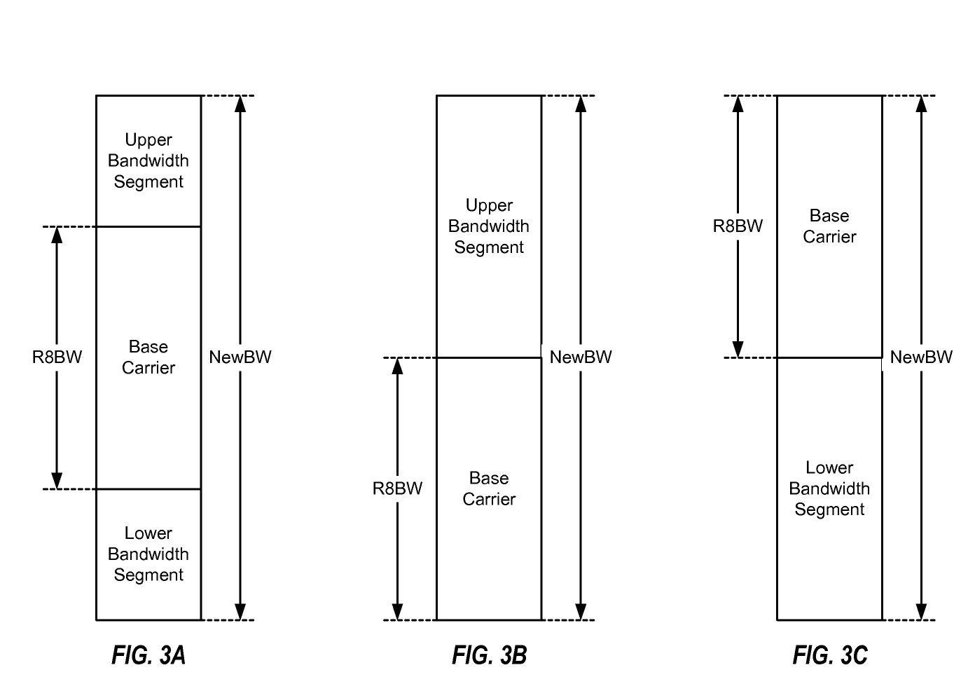

FIG. 3A shows a design of conveying different selected system bandwidths for the legacy and new UEs. The selected system bandwidth for the legacy UEs is denoted as R8BW in FIG. 3A and is referred to as a base carrier. The selected system bandwidth for the new UEs is denoted as NewBW in FIG. 3A and includes the base carrier as well as an upper bandwidth segment at a high end of the base carrier and a lower bandwidth segment at a low end of the base carrier. The upper bandwidth segment may or may not be equal to the lower bandwidth segment.

FIG. 3B shows another design of conveying different selected system bandwidths for the legacy and new UEs. The selected system bandwidth for the legacy UEs is referred to as a base carrier. The selected system bandwidth for the new UEs includes the base carrier as well as an upper bandwidth segment at the high end of the base carrier.

FIG. 3C shows yet another design of conveying different selected system bandwidths for the legacy and new UEs. The selected system bandwidth for the legacy UEs is referred to as a base carrier. The selected system bandwidth for the new UEs includes the base carrier as well as a lower bandwidth segment at the low end of the base carrier.

FIGS. 3A to 3C show three bandwidth operation scenarios that may be conveyed with different NewBW values. In general, any number of segments and any segment size may be used. The segments may or may not be contiguous in frequency with the base carrier for R8BW. Any number of NewBW values may be used to convey any number of bandwidth operation scenarios. For example, NewBW1 may convey two bandwidth segments at both ends of the base carrier as shown in FIG. 3A. NewBW2 may convey one bandwidth segment at the high end of the base carrier as shown in FIG. 3B. NewBW3 may convey one bandwidth segment at the low end of the base carrier as shown in FIG. 3C.

Other bandwidth operation scenarios may also be supported. In another design, different bandwidth operation scenarios may correspond to different bandwidth segment sizes at one or both ends of the base carrier. For example, NewBW1 may convey two bandwidth segments of a first size at both ends of the base carrier. NewBW2 may convey two bandwidth segments of a second size at both ends of the base carrier. NewBW3 may convey two bandwidth segments of a third size at both ends of the base carrier. NewBW3 may also convey one bandwidth segment of a third size at the low or high end of the base carrier.

In one design, the bandwidth segment sizes may be implicitly conveyed. For example, the size of each bandwidth segment may be a predetermined fraction (e.g., one quarter, one half, etc.) of the base carrier. The bandwidth segment sizes may also be dependent on whether one or two bandwidth segments are present. For example, if two bandwidth segments are present, then each bandwidth segment may be one half of the base carrier. If only one bandwidth segment is present, then it may be equal to the base carrier. As an example, an R8BW value may convey 10 MHz system bandwidth for the legacy UEs. For this R8BW value, NewBW1 may indicate two 5 MHz segments at both ends of the base carrier for a system bandwidth of 20 MHz for the new UEs, and NewBW2 may indicate one 10 MHz segment at the high end of the base carrier for a system bandwidth of 20 MHz.

In another design, the bandwidth segment sizes may be explicitly conveyed. Different NewBW values may be used to convey different bandwidth segment sizes. As an example, for a given R8BW value, NewBW1 may indicate a bandwidth segment size of one quarter of the base carrier, NewBW2 may indicate a bandwidth segment size of one half of the base carrier, NewBW3 may indicate a bandwidth segment size equal to the base carrier, etc. For both the implicit and explicit designs, the bandwidth segment sizes may be limited to the set of system bandwidths supported by LTE Releases 8 and 9. Alternatively, the bandwidth segment sizes may have any suitable values.

In general, for the third scheme, a selected system bandwidth (or a base carrier) for the legacy UEs may be conveyed by a 3-bit value in the R8BW field. A selected system bandwidth for the new UEs may be conveyed by the 3-bit value in the R8BW field as well as an M-bit value in the NewBWM field. More bits in the NewBWM field may support more interpretations of the 3-bit value in the R8BW field by the new UEs.

In the design shown in Table 4, the two reserved values for the R8BW field are not used. Additional system bandwidths may be supported by using these reserved values.

Table 5 shows the use of the R8BW field and the NewBW field to convey one or more selected system bandwidths for the downlink in accordance with a second design of the third scheme. In this design, the NewBW field includes 2 bits and supports (i) a first group of 6 system bandwidths defined in LTE Releases 8 and 9 and (ii) 3 additional groups of 6 system bandwidths, as described above for Table 4. A fourth additional group of 8 system bandwidths may be supported for the new UEs by using the two reserved values for the R8BW field and the 2 bits for the NewBW field.

TABLE 5
System Bandwidth Information for Second Design of Third Scheme

| R8BW | NewBW | Legacy UE | New UE |
|---|---|---|---|
| Value | Value | Interpretation | Interpretation |
| 000-101 | 00 | BW = R8BW | BW = R8BW |
| | 01 | BW = R8BW | BW = NewBW1 |
| | 10 | BW = R8BW | BW = NewBW2 |
| | 11 | BW = R8BW | BW = NewBW3 |
| 110 | yy | Cell Barred | BW = 0yy |
| 111 | yy | Cell Barred | BW = 1yy |

To convey a selected system bandwidth from the first group to both the legacy and new UEs, the 3-bit value for the selected system bandwidth may be sent in the R8BW field, and 00 (binary) may be sent in the NewBW field. To convey a first selected system bandwidth from the first group to the legacy UEs as well as a second selected system bandwidth from the first, second or third additional group to the new UEs, the 3-bit value for the first selected system bandwidth may be sent in the R8BW field, and a non-zero value may be sent in the NewBW field. To convey a selected system bandwidth from the fourth additional group to the new UEs, the 3-bit value for the selected system bandwidth may be determined The MSB of the 3-bit value may be sent with either 110 or 111 (binary) in the R8BW field, and the remaining 2 bits (denoted as “yy”) may be sent in the NewBW field, as shown by the last two rows of Table 5.

The legacy UEs may obtain the 3-bit value from the R8BW field and may determine the selected system bandwidth for the legacy UEs based on this 3-bit value. The new UEs may obtain the 3-bit value from the R8BW field as well as the 2-bit value from the NewBW field and may determine the selected system bandwidth for the new UEs based on both the 3-bit value and the 2-bit value.

The design shown in Table 5 may be considered as a combination of the design shown in Table 3 and the design shown in Table 4. The design in Table 5 can support (i) up to 4×6=24 system bandwidths in the first four rows using the reused bitmapping and (ii) up to 8 system bandwidths in the last two rows using the non-reused bitmapping. A total of up to 24+8=32 system bandwidths, or 5 bits worth of information, may be supported for the new UEs by the design shown in Table 5.

The system bandwidths covered by the first four rows of Table 5 for the new UEs may be denoted as subset S1. The system bandwidths covered by the last two rows of Table 5 for the new UEs may be denoted as subset S2. Subsets 51 and S2 may or may not be mutually exclusive. The 5-bit worth information in the R8BW field and the NewBW field may be considered as indicating 32 possible system bandwidth operation scenarios for the new UEs and the legacy UEs.

The system may also operate with a configurable system bandwidth for the uplink, which may be selected from a set of supported system bandwidths for the uplink. LTE Releases 8 and 9 define six supported system bandwidths for the uplink, which are listed in Table 1. The selected system bandwidth for the uplink may be conveyed by broadcasting the 3-bit value of the selected system bandwidth in an R8BWUL field of a system information block type 2 (SIB2) to UEs. SIB2 is a system information message that is broadcast periodically by each cell. It may be desirable to support more than six system bandwidths for the uplink.

Additional system bandwidths for the uplink may be supported in similar manner as for the downlink. For example, a first group of 6 system bandwidths defined in LTE Releases 8 and 9 and a second group of additional system bandwidths for the uplink may be conveyed using the first or second scheme described above. The first group of 6 system bandwidths and one or more additional groups of system bandwidths for the uplink may also be conveyed using the third scheme described above.

System bandwidth information for the downlink may be broadcast separately from system bandwidth information for the uplink, as in LTE Releases 8 and 9. In this case, the system bandwidth information for the downlink may (i) include the same or different numbers of bits and (ii) have the same or different interpretations as the system bandwidth information for the uplink.

It may be desirable to have the selected system bandwidth for the uplink be dependent on the selected system bandwidth for the downlink. This may be the case, e.g., when the downlink system bandwidth includes a backward compatible portion, and the uplink system bandwidth also needs to include a backward compatible portion.

In a fourth scheme, a selected system bandwidth for the uplink may be conveyed using existing bits in the R8BWUL field for the uplink and one or more bits used to convey a selected system bandwidth for the downlink. Additional system bandwidths for the downlink may be conveyed using the NewBW field, as described above. A value in the NewBW field for the downlink may be used in combination with a value in the R8BWUL field for the uplink to interpret the selected system bandwidth for the uplink. The fourth scheme can support additional system bandwidths for the uplink without using any additional bits.

Table 6 shows the use of the R8BWUL field for the uplink and the NewBW field for the downlink to convey a selected system bandwidth for the uplink in accordance with one design of the fourth scheme. In this design, the NewBW field includes 2 bits and is used to support (i) a first group of 6 system bandwidths for the uplink defined in LTE Releases 8 and 9, which is denoted as R8BWUL, and (ii) 3 additional groups of 6 system bandwidths for the uplink, which are denoted as NewBW1UL, NewBW2UL and NewBW3UL. A fourth additional group of 8 system bandwidths for the uplink may be supported for the new UEs by using the two reserved values for the R8BWUL field and the 2 bits for the NewBW field. Two or more of the additional groups may have the same interpretation. For example, NewBW1UL may be equal to NewBW2UL for one or more R8BWUL values. The additional groups of system bandwidths for the uplink may be defined as described above for the downlink.

TABLE 6
System Bandwidth Information for Fourth Scheme

| R8BWUL | | | |
|---|---|---|---|
| Value | NewBW Value | Legacy UE | New UE |
| (for Uplink) | (for Downlink) | Interpretation | Interpretation |
| 000-101 | 00 | BW = R8BWUL | BW = R8BWUL |
| | 01 | BW = R8BWUL | BW = NewBW1UL |
| | 10 | BW = R8BWUL | BW = NewBW2UL |
| | 11 | BW = R8BWUL | BW = NewBW3UL |
| 110 | yy | Cell Barred | BW = 0yy |
| 111 | yy | Cell Barred | BW = 1yy |

For the design shown in Table 6, the legacy UEs may determine the selected system bandwidth for the uplink based on the 3-bit value sent in the R8BWUL field in SIB2. The new UEs may determine the selected system bandwidth for the uplink based on the 3-bit value sent in the R8BWUL field as well as the 2-bit value sent in the NewBW field in the MIB.

In a fifth scheme, a selected system bandwidth for the uplink may be conveyed using existing bits in the R8BWUL field for the uplink, one or more bits used to convey a selected system bandwidth for the downlink, and one or more additional bits in a NewBWUL field for the uplink. More additional groups of system bandwidths for the uplink may be supported by using the additional bits in the NewBWUL field. The additional groups of system bandwidths may be defined in various manners. For example, one or more additional groups of system bandwidths for the uplink may be defined to be related to the system bandwidths for the downlink whereas one or more other additional groups may be defined to be unrelated to the system bandwidths for the downlink.

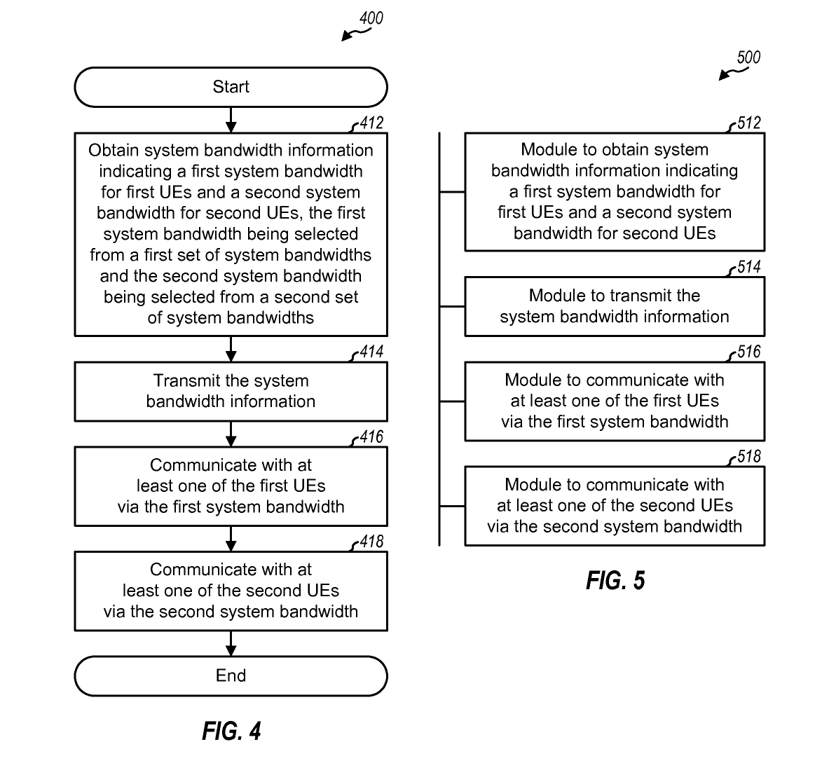

FIG. 4 shows a design of a process 400 for sending system bandwidth information. Process 400 may be performed by a base station (as described below) or by some other entity. The base station may obtain system bandwidth information indicating a first system bandwidth for first UEs and a second system bandwidth for second UEs (block 412). The first system bandwidth may be selected from a first set of system bandwidths, and the second system bandwidth may be selected from a second set of system bandwidths. The second set may be a superset of the first set and may include all system bandwidths in the first set and at least one additional system bandwidth. The first UEs (e.g., legacy UEs) and the second UEs (e.g., new UEs) may support different system releases. One system release (e.g., LTE Release 8 or 9) may support the first set of system bandwidths, and another system release (e.g., LTE Release 10 or later) may support the first and second sets of system bandwidths.

The base station may transmit the system bandwidth information (block 414). The base station may communicate with at least one of the first UEs via the first system bandwidth (block 416) and may communicate with at least one of the second UEs via the second system bandwidth (block 418). For example, the base station may transmit data to and/or receive data from the UEs via the first and second system bandwidths.

The second system bandwidth may be equal to the first system bandwidth. The second system bandwidth may also be different from the first system bandwidth. The first and second system bandwidths may be for the downlink, and the system bandwidth information may be sent in MIB and/or some other message. The first and second system bandwidths may also be for the uplink, and the system bandwidth information may be sent in SIB2 and/or some other message.

In one design, the system bandwidth information may comprise a first part and a second part. The first part may convey the first system bandwidth for the first UEs. The first and second parts may convey the second system bandwidth for the second UEs. The first and second parts may be sent in an R8BW field and a NewBW field, respectively, in FIG. 2B or in some other fields. In one design, the first part may comprise a 3-bit value, and the second part may comprise a K-bit value, where K may be one or greater. The first and second parts may also have other sizes.

In one design, the first system bandwidth may be non-zero if the first part includes a value within a range of valid values, and a cell may be inaccessible by the first UEs (or barred) if the first part includes a reserved value. In one design, the range of valid values may include binary values of 000 through 101 corresponding to six system bandwidths in the first set. The reserved value may be a binary value of 110 or 111. The range of valid values and the reserved values may also include other binary values.

For the first and second schemes described above, the second system bandwidth may be equal to the first system bandwidth if the first part includes a value within the range of valid values. The second system bandwidth may be different from the first system bandwidth and may be determined (i) based on the second part if the first part includes a reserved value (for the first scheme) or (ii) based on the second part and the reserved value if it is included in the first part (for the second scheme).

For the third scheme described above, the second system bandwidth may be equal to the first system bandwidth if the first part includes a value within the range of valid values and the second part includes a designated value (e.g., a binary value of 00). The second system bandwidth may be different from the first system bandwidth and may be determined (i) based on a valid value in the first part and a second value in the second part, e.g., as shown in Table 4, or (ii) based on a reserved value in the first part and the second value in the second part, e.g., as shown by the last two rows in Table 5.

In one design, the first and second parts may convey system bandwidths for a given uplink, e.g., the downlink or uplink. In another design, for the fourth scheme described above, the first part may convey system bandwidths for one link (e.g., the uplink), and the second part may convey system bandwidths for both links (e.g., the uplink and downlink). The first and second system bandwidths may be for the uplink and may be determined based on the first part sent for the uplink and the second part sent for the downlink.

In one design, the system bandwidth information may indicate an absolute value of the second system bandwidth. In another design, the system bandwidth information may indicate whether the second system bandwidth includes (i) a bandwidth segment at one end of the first system bandwidth, as shown in FIG. 3B or 3C, or (ii) two bandwidth segments at both ends of the first system bandwidth, as shown in FIG. 3A. Each bandwidth segment may have a size that may be determined based on the first system bandwidth, or the number of bandwidth segments included in the second system bandwidth, or the value of the second part, and/or some other information.

FIG. 5 shows a design of an apparatus 500 for sending system bandwidth information. Apparatus 500 includes a module 512 to obtain system bandwidth information indicating a first system bandwidth for first UEs and a second system bandwidth for second UEs, a module 514 to transmit the system bandwidth information, a module 516 to communicate with at least one of the first UEs via the first system bandwidth, and a module 518 to communicate with at least one of the second UEs via the second system bandwidth.

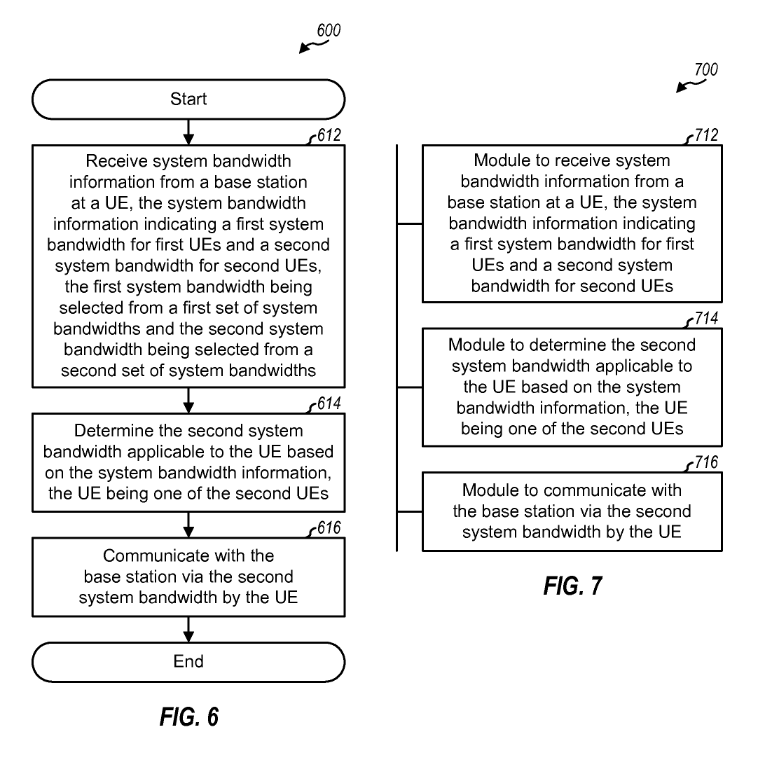

FIG. 6 shows a design of a process 600 for receiving system bandwidth information. Process 600 may be performed by a UE (as described below) or by some other entity. The UE may receive system bandwidth information from a base station (block 612). The system bandwidth information may indicate a first system bandwidth for first UEs and a second system bandwidth for second UEs. The first system bandwidth may be selected from a first set of system bandwidths, and the second system bandwidth may be selected from a second set of system bandwidths. The UE may be one of the second UEs and may determine the second system bandwidth applicable to the UE based on the system bandwidth information (block 614). The UE may communicate with (e.g., send data to and/or receive data from) the base station via the second system bandwidth (block 616).

In one design of block 614, the UE may obtain a first part and a second part of the system bandwidth information. The first part may be used to convey the first system bandwidth for the first UEs, and the first and second parts may be used to convey the second system bandwidth for the second UEs. The UE may determine the second system bandwidth based on the first and second parts.

For the first and second schemes described above, the UE may determine that the second system bandwidth is equal to the first system bandwidth if the first part includes a value within a range of valid values. For the first scheme, the UE may determine the second system bandwidth based on the second part if the first part includes a reserved value. For the second scheme, the UE may determine that the first part includes a reserved value and may then determine the second system bandwidth based on the second part and the reserved value.

For the third scheme, the UE may determine that the second system bandwidth is equal to the first system bandwidth if the first part includes a value within the range of valid values and the second part includes a designated value (e.g., a binary value of 00). The UE may determine that the first part includes a value within the range of valid values and may determine the second system bandwidth from among a first plurality of additional system bandwidths based on the valid value in the first part and a second value in the second part, e.g., as shown in Table 4. The UE may determine that the first part includes a reserved value and may determine the second system bandwidth from among a second plurality of additional system bandwidths based on the reserved value in the first part and the second value in the second part.

In one design, the first and second parts may convey system bandwidths for the downlink or the uplink. In another design, for the fourth scheme, the first part may convey system bandwidths for the uplink, and the second part may convey system bandwidths for both the uplink and downlink. The UE may determine the first and second system bandwidths for the uplink based on the first part sent for the uplink and the second part sent for the downlink.

In one design, the UE may obtain an absolute value for the second system bandwidth based on the system bandwidth information. In another design, the UE may determine whether the second system bandwidth includes (i) a bandwidth segment at one end of the first system bandwidth or (ii) two bandwidth segments at both ends of the first system bandwidth based on the system bandwidth information. The UE may also determine the size of each bandwidth segment based on the first system bandwidth, or the number of bandwidth segments included in the second system bandwidth, or the value of the second part, and/or some other information.

FIG. 7 shows a design of an apparatus 700 for receiving system bandwidth information. Apparatus 700 includes a module 712 to receive system bandwidth information from a base station at a UE, with the system bandwidth information indicating a first system bandwidth for first UEs and a second system bandwidth for second UEs, a module 714 to determine the second system bandwidth applicable to the UE based on the system bandwidth information, with the UE being one of the second UEs, and a module 716 to communicate with the base station via the second system bandwidth by the UE.

The modules in FIGS. 5 and 7 may comprise processors, electronic devices, hardware devices, electronic components, logical circuits, memories, software codes, firmware codes, etc., or any combination thereof.

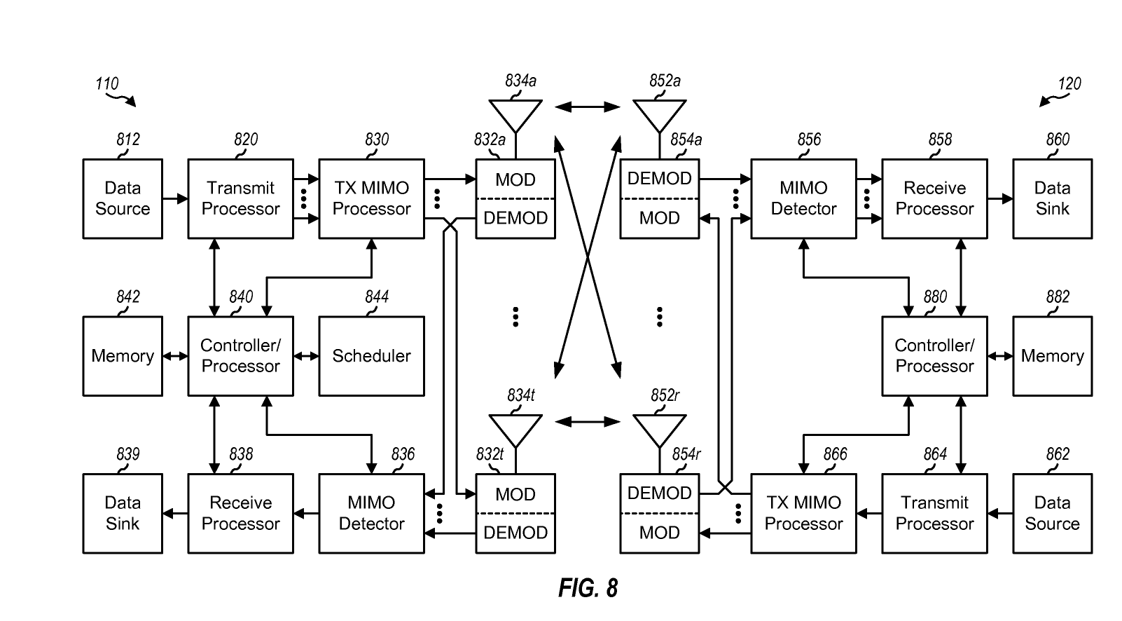

FIG. 8 shows a block diagram of a design of a base station/eNB 110 and a UE 120, which may be one of the base stations/eNBs and one of the UEs in FIG. 1. Base station 110 may be equipped with T antennas 834a through 834t, and UE 120 may be equipped with R antennas 852a through 852r, where in general T1 and R1.

At base station 110, a transmit processor 820 may receive data for one or more UEs from a data source 812 and control information (e.g., system bandwidth information) from a controller/processor 840. Processor 820 may process (e.g., encode, interleave, and modulate) the data and control information to obtain data symbols and control symbols, respectively. A transmit (TX) multiple-input multiple-output (MIMO) processor 830 may perform spatial processing (e.g., precoding) on the data symbols, the control symbols, and/or pilot symbols, if applicable, and may provide T output symbol streams to T modulators (MODs) 832a through 832t. Each modulator 832 may process a respective output symbol stream (e.g., for OFDM, etc.) to obtain an output sample stream. Each modulator 832 may further process (e.g., convert to analog, amplify, filter, and upconvert) the output sample stream to obtain a downlink signal. T downlink signals from modulators 832a through 832t may be transmitted via T antennas 834a through 834t, respectively.

At UE 120, antennas 852a through 852r may receive the downlink signals from base station 110 and may provide received signals to demodulators (DEMODs) 854a through 854r, respectively. Each demodulator 854 may condition (e.g., filter, amplify, downconvert, and digitize) its received signal to obtain input samples. Each demodulator 854 may further process the input samples (e.g., for OFDM, etc.) to obtain received symbols. A MIMO detector 856 may obtain received symbols from all R demodulators 854a through 854r, perform MIMO detection on the received symbols if applicable, and provide detected symbols. A receive processor 858 may process (e.g., demodulate, deinterleave, and decode) the detected symbols, provide decoded data for UE 120 to a data sink 860, and provide decoded control information to a controller/processor 880.

On the uplink, at UE 120, a transmit processor 864 may receive and process data from a data source 862 and control information from controller/processor 880. The symbols from transmit processor 864 may be precoded by a TX MIMO processor 866 if applicable, further processed by modulators 854a through 854r (e.g., for SC-FDM, etc.), and transmitted to base station 110. At base station 110, the uplink signals from UE 120 may be received by antennas 834, processed by demodulators 832, detected by a MIMO detector 836 if applicable, and further processed by a receive processor 838 to obtain decoded data and control information sent by UE 120. Processor 838 may provide the decoded data to a data sink 839 and the decoded control information to controller/processor 840.

Controllers/processors 840 and 880 may direct the operation at base station 110 and UE 120, respectively. Processor 840 and/or other processors and modules at base station 110 may perform or direct process 400 in FIG. 4 and/or other processes for the techniques described herein. Processor 880 and/or other processors and modules at UE 120 may perform or direct process 600 in FIG. 6 and/or other processes for the techniques described herein. Memories 842 and 882 may store data and program codes for base station 110 and UE 120, respectively. A scheduler 844 may schedule UEs for data transmission on the downlink and/or uplink.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for wireless communication, comprising:
obtaining system bandwidth information indicating a first system bandwidth for first user equipments (UEs) and a second system bandwidth for second UEs, the first system bandwidth being selected from a first set of system bandwidths and the second system bandwidth being selected from a second set of system bandwidths; and
transmitting the system bandwidth information.

2. The method of claim 1, wherein the second set of system bandwidths is a superset of the first set of system bandwidths and includes all system bandwidths in the first set and at least one additional system bandwidth.

3. The method of claim 1, wherein the first UEs and the second UEs support different system releases, wherein one of the system releases supports the first set of system bandwidths, and wherein another one of the system releases supports the first and second sets of system bandwidths.

4. The method of claim 1, wherein the system bandwidth information comprises a first part and a second part, the first part conveying the first system bandwidth for the first UEs, and the first and second parts conveying the second system bandwidth for the second UEs.

5. The method of claim 4, wherein the first system bandwidth is non-zero if the first part includes a value within a range of valid values, and wherein a cell is inaccessible by the first UEs if the first part includes a reserved value.

6. The method of claim 5, wherein the range of valid values includes binary values of 000 through 101 corresponding to six system bandwidths in the first set, and wherein the reserved value is a binary value of 110 or 111.

7. The method of claim 4, wherein the second system bandwidth is equal to the first system bandwidth if the first part includes a value within a range of valid values.

8. The method of claim 4, wherein the second system bandwidth is determined based on the second part if the first part includes a reserved value.

9. The method of claim 4, wherein if the first part includes a reserved value, the second system bandwidth is determined based on the second part and the reserved value.

10. The method of claim 4, wherein the second system bandwidth is equal to the first system bandwidth if the first part includes a value within a range of valid values and the second part includes a designated value.

11. The method of claim 4, wherein if the first part includes a first value within a range of valid values, the second system bandwidth is determined based on the first value in the first part and a second value in the second part.

12. The method of claim 4, wherein if the first part includes a reserved value, the second system bandwidth is determined based on the reserved value in the first part and a second value in the second part.

13. The method of claim 4, wherein the first and second system bandwidths are for uplink, and wherein the first part conveys system bandwidths for the uplink and the second part conveys system bandwidths for the uplink and downlink.

14. The method of claim 1, wherein the second system bandwidth is different from the first system bandwidth.

15. The method of claim 1, wherein the system bandwidth information indicates whether the second system bandwidth includes a bandwidth segment at one end of the first system bandwidth or two bandwidth segments at both ends of the first system bandwidth.

16. The method of claim 15, wherein each bandwidth segment has a size determined based on the first system bandwidth, or the number of bandwidth segments included in the second system bandwidth, or both.

17. The method of claim 1, wherein the system bandwidth information indicates the second system bandwidth including a plurality of bandwidth segments contiguous with the first system bandwidth.

18. The method of claim 1, further comprising:
communicating with at least one of the first UEs via the first system bandwidth; and
communicating with at least one of the second UEs via the second system bandwidth.

19. An apparatus for wireless communication, comprising:
means for obtaining system bandwidth information indicating a first system bandwidth for first user equipments (UEs) and a second system bandwidth for second UEs, the first system bandwidth being selected from a first set of system bandwidths and the second system bandwidth being selected from a second set of system bandwidths; and
means for transmitting the system bandwidth information.

20. The apparatus of claim 19, wherein the system bandwidth information comprises a first part and a second part, the first part conveying the first system bandwidth for the first UEs, and the first and second parts conveying the second system bandwidth for the second UEs.

21. The apparatus of claim 20, wherein the first system bandwidth is non-zero if the first part includes a value within a range of valid values, and wherein a cell is inaccessible by the first UEs if the first part includes a reserved value.

22. The apparatus of claim 20, wherein the second system bandwidth is equal to the first system bandwidth if the first part includes a value within a range of valid values or if the first part includes a value within the range of valid values and the second part includes a designated value.

23. The apparatus of claim 20, wherein the second system bandwidth is different from the first system bandwidth and is determined based on the second part if the first part includes a reserved value, or based on the second part and the reserved value if the first part includes the reserved value, or based on the second part and a valid value in the first part if the first part includes the valid value.

24. An apparatus for wireless communication, comprising:
at least one processor configured to obtain system bandwidth information indicating a first system bandwidth for first user equipments (UEs) and a second system bandwidth for second UEs, the first system bandwidth being selected from a first set of system bandwidths and the second system bandwidth being selected from a second set of system bandwidths, and to transmit the system bandwidth information.

25. The apparatus of claim 24, wherein the system bandwidth information comprises a first part and a second part, the first part conveying the first system bandwidth for the first UEs, and the first and second parts conveying the second system bandwidth for the second UEs.

26. The apparatus of claim 25, wherein the first system bandwidth is non-zero if the first part includes a value within a range of valid values, and wherein a cell is inaccessible by the first UEs if the first part includes a reserved value.

27. The apparatus of claim 25, wherein the second system bandwidth is equal to the first system bandwidth if the first part includes a value within a range of valid values or if the first part includes a value within the range of valid values and the second part includes a designated value.

28. The apparatus of claim 25, wherein the second system bandwidth is different from the first system bandwidth and is determined based on the second part if the first part includes a reserved value, or based on the second part and the reserved value if the first part includes the reserved value, or based on the second part and a valid value in the first part if the first part includes the valid value.

29. A computer program product, comprising:
a computer-readable medium comprising:
code for causing at least one processor to obtain system bandwidth information indicating a first system bandwidth for first user equipments (UEs) and a second system bandwidth for second UEs, the first system bandwidth being selected from a first set of system bandwidths and the second system bandwidth being selected from a second set of system bandwidths, and
code for causing the at least one processor to transmit the system bandwidth information.

30. A method for wireless communication, comprising:
receiving system bandwidth information from a base station at a user equipment (UE), the system bandwidth information indicating a first system bandwidth for first UEs and a second system bandwidth for second UEs, the first system bandwidth being selected from a first set of system bandwidths and the second system bandwidth being selected from a second set of system bandwidths;
determining the second system bandwidth applicable to the UE based on the system bandwidth information, the UE being one of the second UEs; and
communicating with the base station via the second system bandwidth by the UE.

31. The method of claim 30, wherein the determining the second system bandwidth comprises
obtaining a first part and a second part of the system bandwidth information, the first part being used to convey the first system bandwidth for the first UEs, and the first and second parts being used to convey the second system bandwidth for the second UEs, and
determining the second system bandwidth based on the first and second parts.

32. The method of claim 31, wherein the determining the second system bandwidth based on the first and second parts comprises determining that the second system bandwidth is equal to the first system bandwidth if the first part includes a value within a range of valid values.

33. The method of claim 31, wherein the determining the second system bandwidth based on the first and second parts comprises determining the second system bandwidth based on the second part if the first part includes a reserved value.

34. The method of claim 31, wherein the determining the second system bandwidth based on the first and second parts comprises
determining that the first part includes a reserved value, and
determining the second system bandwidth based on the second part and the reserved value.

35. The method of claim 31, wherein the determining the second system bandwidth based on the first and second parts comprises determining that the second system bandwidth is equal to the first system bandwidth if the first part includes a value within a range of valid values and the second part includes a designated value.

36. The method of claim 31, wherein the determining the second system bandwidth based on the first and second parts comprises
determining that the first part includes a first value within a range of valid values, and
determining the second system bandwidth based on the first value in the first part and a second value in the second part.

37. The method of claim 31, wherein the determining the second system bandwidth based on the first and second parts comprises
determining that the first part includes a reserved value, and
determining the second system bandwidth based on the reserved value in the first part and a second value in the second part.

38. The method of claim 31, wherein the first and second system bandwidths are for uplink, and wherein the first part conveys system bandwidths for the uplink and the second part conveys system bandwidths for the uplink and downlink.

39. The method of claim 30, wherein the determining the second system bandwidth comprises determining whether the second system bandwidth includes a bandwidth segment at one end of the first system bandwidth or two bandwidth segments at both ends of the first system bandwidth based on the system bandwidth information.

40. An apparatus for wireless communication, comprising:
means for receiving system bandwidth information from a base station at a user equipment (UE), the system bandwidth information indicating a first system bandwidth for first UEs and a second system bandwidth for second UEs, the first system bandwidth being selected from a first set of system bandwidths and the second system bandwidth being selected from a second set of system bandwidths;
means for determining the second system bandwidth applicable to the UE based on the system bandwidth information, the UE being one of the second UEs; and
means for communicating with the base station via the second system bandwidth by the UE.

41. The apparatus of claim 40, wherein the means for determining the second system bandwidth comprises
means for obtaining a first part and a second part of the system bandwidth information, the first part being used to convey the first system bandwidth for the first UEs, and the first and second parts being used to convey the second system bandwidth for the second UEs, and
means for determining the second system bandwidth based on the first and second parts.

42. The apparatus of claim 41, wherein the means for determining the second system bandwidth based on the first and second parts comprises means for determining that the second system bandwidth is equal to the first system bandwidth if the first part includes a value within a range of valid values or if the first part includes a value within the range of valid values and the second part includes a designated value.

43. The apparatus of claim 41, wherein the means for determining the second system bandwidth based on the first and second parts comprises
means for determining that the first part includes a reserved value, and
means for determining the second system bandwidth based on the second part or based on the second part and the reserved value.

44. The apparatus of claim 41, wherein the means for determining the second system bandwidth based on the first and second parts comprises
means for determining that the first part includes a first value within a range of valid values, and
means for determining the second system bandwidth based on the first value in the first part and a second value in the second part.
